(19) United States
(12) Patent Application Publication
(10) Pub. No.: US 2013/0061487 A1
(43) Pub. Date: Mar. 14, 2013

(54) CARPET CENTRIFUGE WITH EXTERNAL PLACEMENT

(71) Applicant: Andreas Peter QUENSELL IGLESIAS, Montevideo (UY)

(72) Inventor: Andreas Peter QUENSELL IGLESIAS, Montevideo (UY)

(21) Appl. No.: 13/555,291

(22) Filed: Jul. 23, 2012

(30) Foreign Application Priority Data
Sep. 13, 2011 (UY) U4392

(51) Int. Cl. F26B 19/00

(52) U.S. Cl. 34/58

(57) ABSTRACT

A carpet centrifuge with external placement for industrial cleaning of carpets and other large textile articles.

### FIELD OF THE INVENTION

A carpet centrifuge with external placement for use mainly in establishments engaged in industrial cleaning of carpets and other large textile articles.

### BACKGROUND OF THE INVENTION

When using a carpet centrifuge in which carpets or other large textile articles are placed inside a cylinder, usually the carpets or other large textile articles exert an irregular pressure on the sides of the cylinder and, therefore, the cylinder becomes imbalanced, which does not allow the cylinder to spin at high speed. Thus, the essence of the spinning system is lost and the desired effectiveness of a good spin-drying process is not achieved.

### SUMMARY OF THE INVENTION

The present invention relates to a carpet centrifuge with external placement, meant to the industrial spin-drying of carpets. Thus, this invention is intended for obtaining the maximum expected effectiveness in a good spin drying, removing the greatest amount of water from the carpet and obtaining a fast drying.

Unlike traditional carpet centrifuges, this invention does not include a cylinder. Instead, it includes a perforated main tube with holes fastened to a central internal shaft in its two lateral ends by two spoke wheels, which transfer rotation power from the central driving shaft to the before mentioned tube. An electrical engine feeds the central driving shaft through a pulley and two inverted V-shaped stands, one at each end, support the central driving shaft. The carpet or large textile article is rolled up around the perforated tube with holes. A mesh holds the carpet on the outer side, to allow its correct spin-drying.

The maximum effectiveness expected in a carpet centrifuge for industrial use is achieved through the carpet or other large textile article external placement. When placing the carpet or other large textile article in the outer side of the carpet centrifuge around the perforated tube with holes, it can be uniformly accommodated, thus the undesired imbalance does not occur and the carpet centrifuge is able to reach higher rpm, making the spin much more effective than the one described in the background. Externally, above the carpet or other large textile article, a mesh prevents the carpet or other large textile article from moving. The external placement of the carpet or other large textile article, by rolling it up around the perforated tube with holes, as well as the attachment of the mesh around and over the carpet or other large textile article, provide support for the carpet or other large textile article to be spin-dried. They remain caught between the tube and the mesh, preventing the carpet from moving due to centrifugal force when spinning. This invention has a very important advantage over traditional carpet centrifuges, since it allows the carpet or other large textile article to be accommodated in optimal balance conditions and enables more rpm and an increased diameter of the perforated tube with holes, which replaces the cylinder of traditional carpet centrifuges.

Additionally, water and other products necessary for the cleaning process of carpets and other large textile articles can be added in the perforated tube with holes while the carpet centrifuge is working, in order to improve the rinsing process and finish the carpet preparation prior to the drying process.

The use of the carpet centrifuge disclosed herein has an additional advantage: unwanted pleats or marks do not appear in the carpet.

### BRIEF DESCRIPTION OF THE DRAWINGS

FIG. 1 shows a perspective front view of the carpet centrifuge with external placement according to an exemplary embodiment of the present invention.

FIG. 2 shows an exploded view of the carpet centrifuge of FIG. 1.

FIG. 3 shows a cross-section view A-A′ and frontal view of the carpet centrifuge with external placement.

FIG. 4 shows a cross-section view B-B′ and a left side view of the carpet centrifuge with external placement.

FIG. 5 shows the cross-section B-B′ view described in FIG. 4 shown from the frontal side of the carpet centrifuge with external placement.

FIG. 6 shows the cross-section A-A′ view described in FIG. 3 shown from the right side of the carpet centrifuge with external placement.

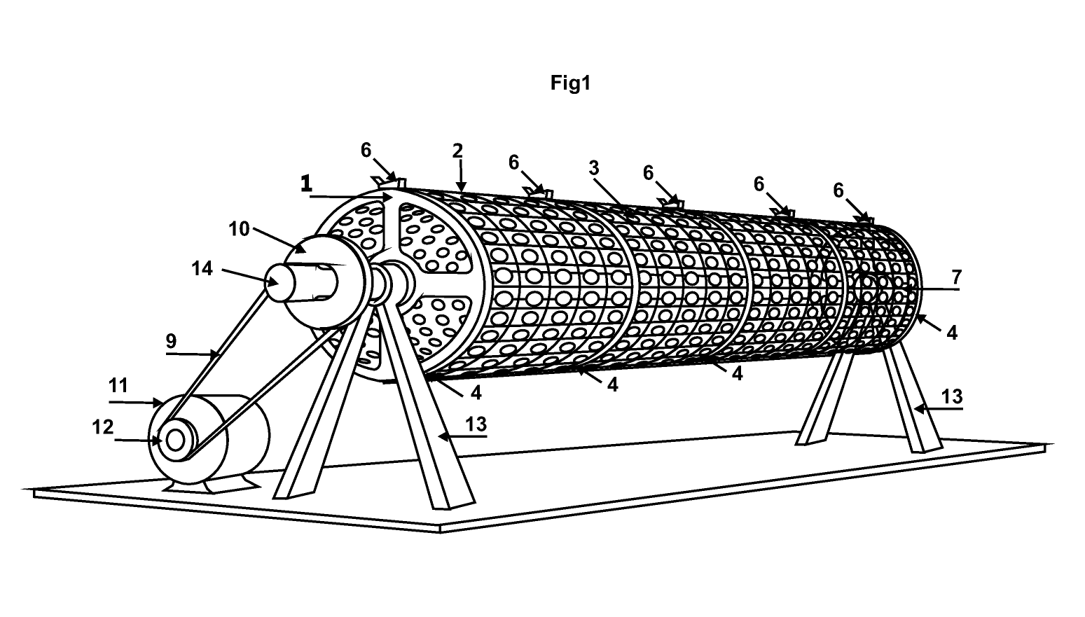

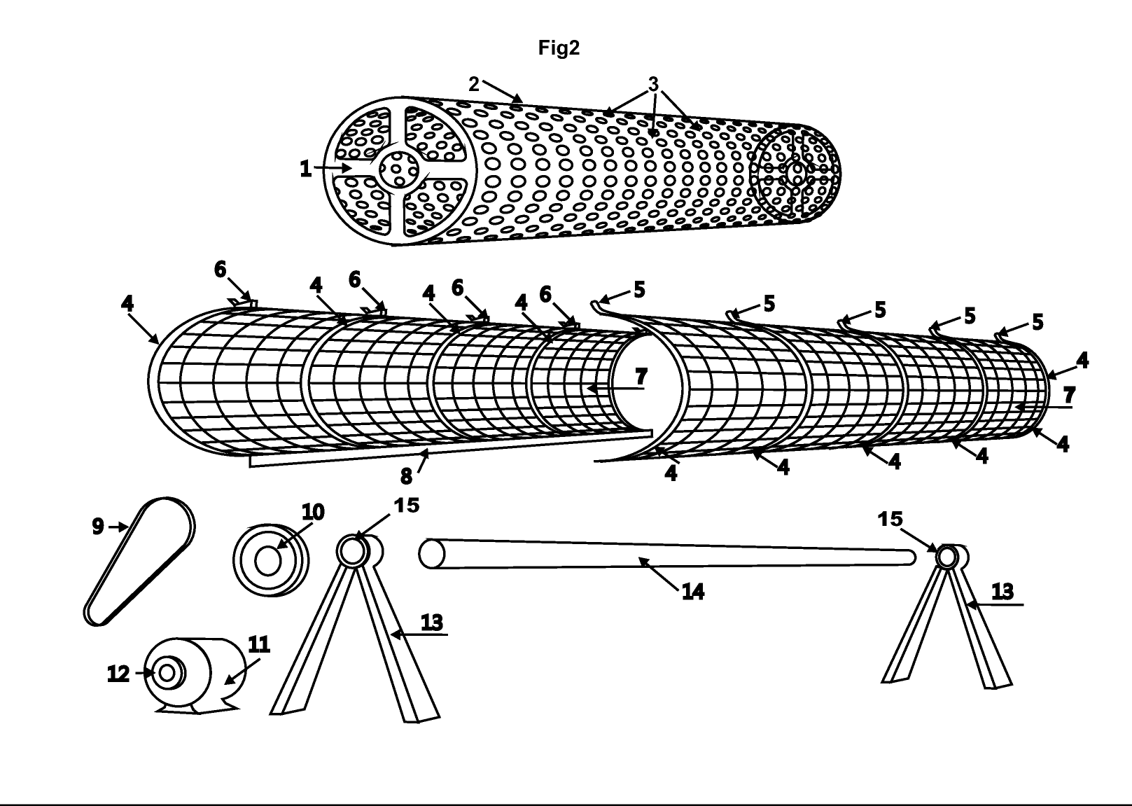

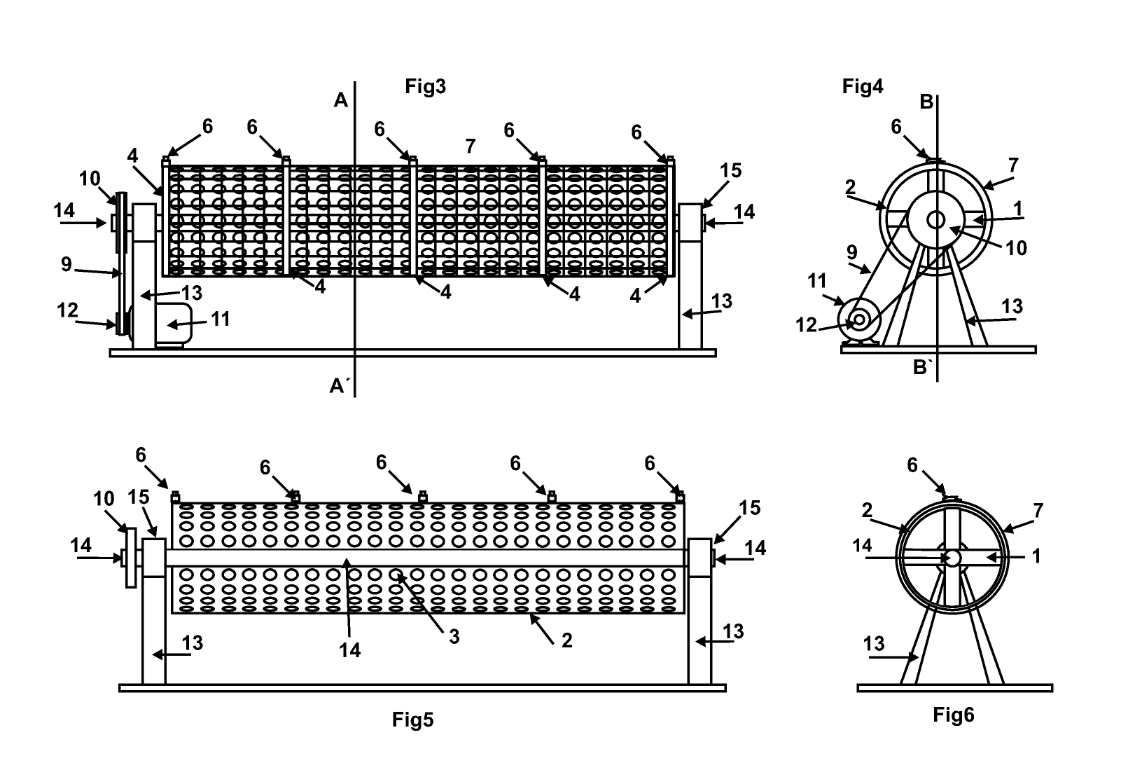

### DETAILED DESCRIPTION OF THE INVENTION

The central driving shaft 14 is a metallic cylindrical rod, preferably made of tempered steel, solid or hollow. In the latter case, there are at least 5 holes all along the shaft 14, three of which are 180° out of phase with respect to the other two. The already described shaft 14 may have a roller bearing in one end and another roller bearing approximately 10 cm far from the opposite end. Each one of these roller bearings is inserted into a bushing, which is held up by an inverted v-shaped stand 13. In addition, roller bearings can be avoided, simply by using bushings. These stands are placed on a correctly level surface. There is a pulley inserted in one end of the shaft, which receives driving power from the engine, through a v-shaped drive belt. The spoke wheels are fitted on the central driving shaft from the inner side of each roller bearing or bushing, approximately two centimeters from them, and inserted at each end of the perforated tube with holes, by their external diameter. Thus, the inner diameter of the perforated tube with holes coincides with the outer diameter of the wheels. The distance between each hole and the other in the perforated tube is shorter than their diameter, thus the tube is entirely perforated. The carpet or large textile article to be spin-dried is rolled up around the perforated tube with holes. A mesh with adjustment means is placed over the textile article to be spin-dried to fasten it to the perforated tube with holes, with no pleats or wrinkles.

The central driving shaft, preferably made of tempered steel is manufactured by lathe operation. The perforated tube with holes, also made of metal, preferably stainless steel, is manufactured by metallurgical industry. Side spoke wheels and pulleys are made of cast metal, by casting and lathe operation. The central driving shaft v-shaped stands are made of metal by metallurgical industry.

The mesh can be manufactured in a flexible material, such as a woven rope or a plastic mesh with appropriate means for adjustment and closing around the carpet, for instance, hooks and rings.

The mesh can also be made of a rigid material, such as metal, preferably stainless steel. In the example shown in the drawings, the metal mesh has a cylindrical shape and has a slightly larger diameter than the perforated tube with holes. As shown in the drawings, the mesh is divided into two parts, joined by a hinge, which allows opening and closing. In addition, it has fastening means to keep it closed once it is placed over the carpet or large textile article to be spin-dried.

Measures for manufacturing could be the following:

Total machine size: 3.5 meters long, 1.20 meters wide, 1.0 meter high.

Shaft: 0.08 meters diameter, 3.5 meters long

Perforated tube: 0.6 meters diameter, 2.5 meters long

Spoke wheel: 0.6 meters outer diameter, 0.08 meters inner diameter

Mesh (woven rope or plastic): 2.5 meters long, 2 meters wide

Mesh (rigid material): 2.5 meters long, 0.65 meters diameter

Stands: 0.7 meters high

The holes in the shaft can be 4 millimeters in diameter. The holes in the perforated tube can be a 1-centimeter diameter and the distance between them should not exceed their diameter.

Side spoke wheels 1 are located in each end of the perforated tube 2 with holes 3. The cylindrical mesh 7 has two parts joined by a hinge 8 which allows opening and closing, fastened with belts 4 which have an end 5 attached to the grippers 6. The perforated tube 2 is fastened by the wheels 1 to the central driving shaft 14 located inside. The central driving shaft 14 is fed with rotational power through the pulley 10 attached to one end of the central driving shaft 14. The pulley 10 receives the power generated by the engine 11, through a drive belt 9 which receives the power through a pulley 12 attached to the shaft of the electrical engine 11. The central driving shaft 14 rotates within bushings 15 supported by stands 13, which are placed on a correctly level surface and are the base of the carpet centrifuge with external placement.

### Operation

The two spoke wheels transmit the rotational power from the central driving shaft to the perforated tube with holes. The central driving shaft is fed through the pulley by the electrical engine through the belt, and the driving shaft is supported by the stands sitting on a level surface.

The carpet or other large textile article wrapped around the perforated tube with holes keeps uniformly accommodated. Therefore, the undesired imbalance that occurs with traditional carpet centrifuges, which include a cylinder, and where textile articles are placed inside, does not occur. The external collocation allows the carpet centrifuge to reach higher rpm, making the spinning much more effective. The external placement of the carpet or other large textile article, as well as the attachment of the mesh around and over the carpet or other large textile article, provide support for the carpet or other large textile article to be spin-dried. The carpet keeps caught between the tube and the mesh, preventing the carpet from moving due to centrifugal force when spinning.

In one embodiment, the cleaning of a carpet begins with the absorption of dry powder by a strong vacuum cleaner. Washing is then performed by the application of a solution of soapy water and brushing. Once the process of shampooing is finished, the carpet is rolled up around the perforated tube with holes and it is caught with the cylindrical mesh, adjusting the straps to the grippers. The mesh protects the carpet, preventing it from moving and being thrown out during the spin cycle.

The spin-drying process lasts a period of approximately 10 minutes, divided in different stages.

In a first stage, only spin-drying is performed for a short period of time, approximately three minutes, in order to remove most of the soapy water and dirtiness.

Then, approximately 20 liters of water are injected by pressure for approximately 45 seconds in, for example, the central hollow driving shaft which works as a water pipe, without stopping the spin-drying process. The water is ejected onto the carpet wrapped around the perforated tube with holes and fastened by the cylindrical mesh through the central driving shaft holes, in order to remove traces of soapy water and dirtiness. The spin-drying continues for approximately 3 more minutes after stopping the water entry.

In the last stage, approximately 5 liters of a solution of water with fragrance and softener is injected by pressure for approximately 15 seconds without stopping the spinning. After stopping the entry of the solution of water with fragrance and softener, the carpet spin-drying continues for a period of about 4 more minutes, thus completing the spin-drying cycle and the carpet remains clean, scented and almost dry.

Once the process is finished, the mesh is opened and the carpet or large textile article is removed.

What is claimed is:

1. A carpet centrifuge with external placement comprising:
a) a stand including:
a central driving metal shaft, the shaft having a first end and a second end;
a first stand secured to the first end of the central driving metal shaft;
a second stand secured to the second end of the central driving metal shaft;
one bushing attached to each end of the central driving metal shaft, each bushing optionally includes a roller bearing inside;
one spoke wheel inserted at each end of the central driving metal shaft;
an engine including a pulley, the pulley operatively connected to one of the central driving metal shaft's ends by a belt; and
b) a perforated tube including holes, the central driving metal shaft is inserted through the perforated tube; and
c) a mesh with fasteners surrounding the perforated tube.

2. The carpet centrifuge according to claim 1, wherein a carpet or a large textile article is placed between the perforated tube and the mesh.

3. The carpet centrifuge according to claim 1, wherein the central driving metal shaft is hollow and has at least five holes, wherein three of the holes are 180° out of phase with respect to the other two.

4. The carpet centrifuge according to claim 1, wherein the mesh is flexible or rigid, wherein the mesh is made of a metallic material, wherein the mesh has a first and a second section which are hinged to each other, wherein the first section and the second section surround the perforated tube, the first section and the second section are secured to each other by using fasteners.

5. The carpet centrifuge according to claim 1, wherein the fasteners are adjustable fasteners.
